(19) United States
(12) Patent Application Publication
(10) Pub. No.: US 2011/0320689 A1
(43) Pub. Date: Dec. 29, 2011

(54) Data Storage Devices and Data Management Methods for Processing Mapping Tables

(76) Inventors: Kyoung Lae Cho, Yongin-si (KR); Jun-jin Kong, Yongin-si (KR); Hong-rak Son, Anyang-si (KR); Seong-hyeong Choi, Hwaseong-si (KR)

(21) Appl. No.: 13/159,075

(22) Filed: Jun. 13, 2011

(30) Foreign Application Priority Data
Jun. 24, 2010 (KR) 10-2010-0060096

(51) Int. Cl. G06F 12/00; G06F 12/10

(52) U.S. Cl. 711/103; 711/206; 711/E12.058; 711/E12.008

(57) ABSTRACT

Methods of operating integrated circuit devices include updating a mapping table with physical address information by reading forward link information from a plurality of spare sectors in a corresponding plurality of pages within a nonvolatile memory device and then writing mapping table information derived from the forward link information into the mapping table. This forward link information may be configured as absolute address information (e.g., next physical address) and/or relative address information (e.g., change in physical address). This updating of the mapping table may include updating a mapping table within a volatile memory, in response to a resumption of power within the integrated circuit device. This resumption of power may follow a power failure during which the contents of the volatile memory are lost.

### REFERENCE TO PRIORITY APPLICATION

This application claims the benefit of Korean Patent Application No. 10-2010-0060096, filed Jun. 24, 2010, the disclosure of which is hereby incorporated herein in its entirety by reference.

### BACKGROUND

The inventive concept relates to a storage medium, and more particularly, to a data storage device, which employs a non-volatile semiconductor memory as a storage medium and may be attached to and detached from a host device, and a method of managing data of the data storage device.

A non-volatile semiconductor memory is used as a large capacity data storage device. For example, non-volatile semiconductor memories are widely used as data storage devices that may be attached to and detached from host devices, such as personal computers (PCs), mobile phones, a mobile audio/video (A/V) devices, etc. In a data storage device, management of a data recording operation and a data reading operation is performed according to a file system of a host device, such as file allocation table (FAT) file system. The physical section within a non-volatile semiconductor memory is divided into a plurality of blocks, and a block is a unit by which data is deleted. Furthermore, a block is divided into a plurality of pages, and a page is a unit by which data is written or read. When data is written, read, and deleted by using a file system, it is necessary to manage relationships of correspondence between logical addresses provided by a system of a host device and physical addresses of a non-volatile semiconductor memory.

### SUMMARY

Methods of operating integrated circuit devices according to embodiments of the invention include updating a mapping table with physical address information. This updating is achieved by reading forward link information from a plurality of spare sectors in a corresponding plurality of pages within a nonvolatile memory device and then writing mapping table information derived from the forward link information into the mapping table. This forward link information may be configured as absolute address information (e.g., next physical address) and/or relative address information (e.g., change in physical address). This updating of the mapping table may further include updating a mapping table within a volatile memory, in response to a resumption of power within the integrated circuit device. This resumption of power may follow a power failure during which the contents of the volatile memory (e.g., mapping table) are lost.

According to some embodiments of the invention, the mapping table within the volatile memory operates as a flash translation layer (FTL) that supports conversion of logical addresses received by the integrated circuit device (e.g., from a host device) into physical addresses within the nonvolatile memory device. The plurality of spare sectors may also retain error checking and correction (ECC) codes and metadata.

According to additional embodiments of the invention, operations may be performed to write updated forward link information into the plurality of spare sectors in response to writing new data into the plurality of pages within a nonvolatile memory device. In some cases, this forward link information may include forward link offset information.

### BRIEF DESCRIPTION OF THE DRAWINGS

Exemplary embodiments of the inventive concept will be more clearly understood from the following detailed description taken in conjunction with the accompanying drawings in which:

FIG. 1 is a diagram of a data storage device according to an embodiment of the inventive concept;

FIG. 2 is a diagram for describing an environment in which the data storage device of FIG. 1 is used;

FIG. 3 is a diagram showing a configuration of a memory sector in the non-volatile semiconductor memory of FIG. 1;

FIG. 4 is a diagram showing a configuration of each of pages of one of the blocks of FIG. 3;

FIG. 5 is a method for describing composition of a map table by using the page configuration as shown in FIG. 3;

FIG. 6 is a diagram showing data stored in a spare sector according to an embodiment of the inventive concept;

FIG. 7 is a diagram for describing a function of forward links of FIG. 6;

FIG. 8 is a diagram for describing a method of managing a non-volatile semiconductor memory by using a plurality of forward links stored in the spare sector of FIG. 6;

FIG. 9 is a flowchart of a method of composing a mapping table as described above with reference to FIG. 8;

FIG. 10 is a diagram showing data stored in a spare sector according to another embodiment of the inventive concept;

FIG. 11 is a diagram for describing a method of managing a non-volatile semiconductor memory by using forward link and link offset stored in a spare sector of FIG. 10;

FIGS. 12 through 14 are diagrams for describing functions of the forward link and the link offset of FIG. 11; and

FIG. 15 is a flowchart of a method of composing a mapping table by using a forward link and a link offset stored in the spare sector of FIG. 10.

### DETAILED DESCRIPTION OF THE EMBODIMENTS

Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by scopes of claims. Like reference numerals refer to like elements throughout.

While specific terms were used in the specification, they were not used to limit the inventive concept, but merely used to explain the exemplary embodiments. In the inventive concept, the terms of a singular form may include plural forms unless otherwise specified. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. Further, in the specification, it will also be understood that when a layer (or film) is referred to as being ‘on’ another layer or substrate, it can be directly on the other layer or substrate, or intervening layers may also be present.

Additionally, the embodiments in the detailed description will be described with sectional views and/or plan views as ideal exemplary views of the inventive concept. In the drawings, the dimensions of layers and regions are exaggerated for clarity of illustration. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. For example, an etched region illustrated as a rectangle may have rounded or curved features. Areas exemplified in the drawings have general properties, and are used to illustrate a specific shape of a device region. Thus, this should not be construed as limited to the scope of the inventive concept.

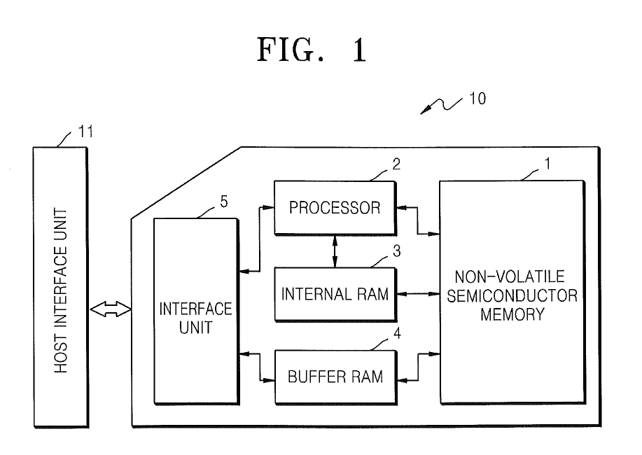

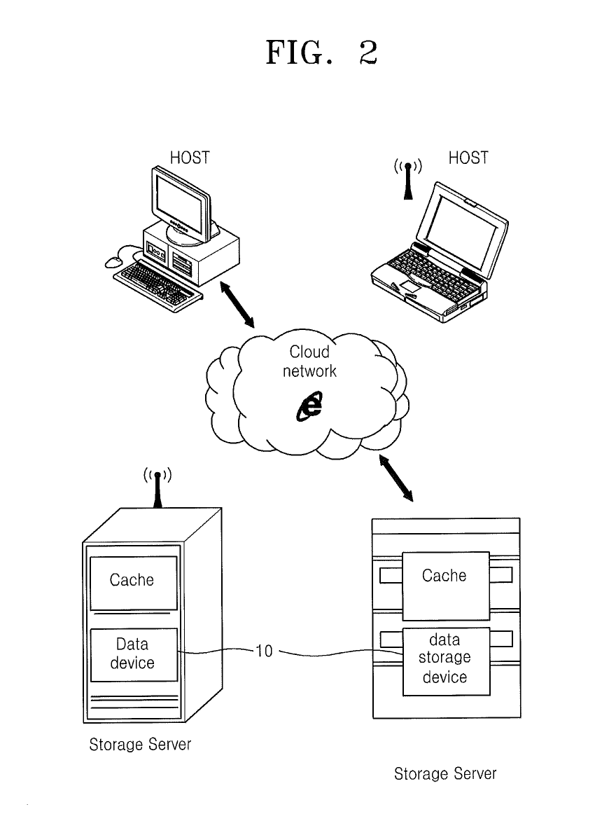

FIG. 1 is a diagram of a data storage device 10 according to an embodiment of the inventive concept. Referring to FIG. 1, the data storage device 10 includes a non-volatile semiconductor memory 1, a processor 2, an internal RAM 3, a buffer RAM 4, and an interface unit 5. As shown in FIG. 2, the data storage device 10 is used in a storage server in a wired/wireless cloud computing system or a distributed shared file system (DSFS), which has at least one host and at least one storage server. Alternatively, the data storage device 10 may be a card-type device, (e.g., a memory card) and is used as a removable memory that may be attached to and detached from a host device, such as a PC, a digital camera, etc. The non-volatile semiconductor memory 1 is a NAND flash memory consisting of either a plurality of single level cells or a plurality of multi-level cells.

The processor 2 is a control unit, which controls the entire operation of the data storage device 10, performs data transmission between the internal RAM 3 or the buffer RAM 4 and the non-volatile semiconductor memory 1, and writes, reads, and deletes data. The internal RAM 3 is used as a storage region for operations of the processor 2. For example, the internal RAM 3 temporarily stores an operation control command with respect to the processor 2, necessary parameters for executing the operation control command, the internal state of the data storage device 10, etc. Furthermore, when data read out from the non-volatile semiconductor memory 1 is being written to the non-volatile semiconductor memory 1, the internal RAM 3 temporarily stores the data. The buffer RAM 4 functions as a so-called page buffer, temporarily stores data to be written and transmitted from a host device via the interface unit 5, and temporarily stores data read out from the non-volatile semiconductor memory 1 via the interface unit 5 to transmit the data to the host device.

The interface unit 5 interfaces with a host interface unit 11 of the host device. The interface unit 5 includes a serial interface, which transmits data via 3 signal lines according to a serial protocol, and a parallel interface, which transmits data via 6 signal lines according to a parallel protocol, for example.

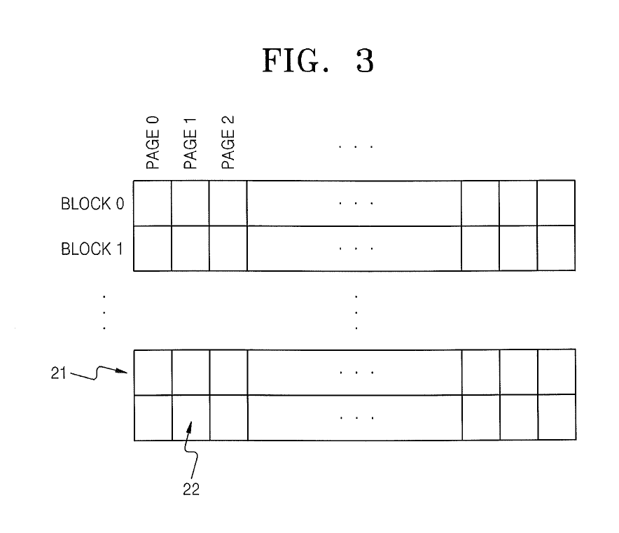

FIG. 3 is a diagram showing a configuration of a memory sector in the non-volatile semiconductor memory 1 of FIG. 1. Referring to FIG. 3, the memory sector is divided into a plurality of blocks 21, (e.g., block 0, block 1, and so on). Each of the blocks 21 is a unit by which data is deleted. Each of the blocks 21 is divided into a plurality of pages 22 (e.g., page 0, page 1, page 2, and so on), each of which is a unit by which data is written or read.

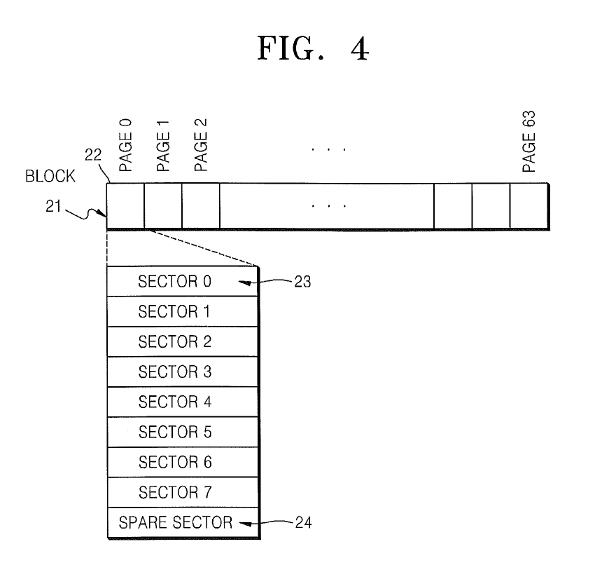

FIG. 4 is a diagram showing a configuration of each of the pages 22 of one of the blocks 21. Referring to FIG. 4, the block 21 consists of 64 pages 22, for example, and each of the pages 22 includes a plurality of sectors 23 (e.g., 8 sectors), which are sectors to which data is stored, and a spare sector 24, to which error correction codes and other metadata are stored. Various pieces of data related to each of the pages 22 are stored in the spare sector 24, wherein the various pieces of data include logical addresses of each piece of data in a logic space allocated by a host device, ECC parities, numbers of cycles of programming and erasing, etc. Before data is written to a memory sector of the non-volatile semiconductor memory 1, data deletion by block shall be performed. In other words, it is necessary to restore memory cells to an initial state at which data may be written to the memory cells. A deleting operation generally requires a significantly longer period of time as compared to a writing operation. Furthermore, since a deleting operation is performed by a significantly larger block as compared to a writing operation by page, portions not requested to be deleted are also deleted. Since it is necessary to restore inevitably deleted portions via re-writing deleted data, one data writing request may require one data deleting operation and an operation of writing as much data as the deleted data. Accordingly, due to inconsistency between units by which deleting and writing operations are performed, the performance of a writing operation is significantly inefficient, as compared to the performance of a reading operation.

Due to the characteristic of the non-volatile semiconductor memory 1, a flash translation layer (referred to hereinafter as “FTL”) intervenes between a file system of a host device and the non-volatile semiconductor memory 1 to manage the non-volatile semiconductor memory 1. During an operation of writing data to the non-volatile semiconductor memory 1, the FTL maps logical addresses generated by a file system to physical addresses of the non-volatile semiconductor memory 1 to which a deletion process is performed. The FTL uses an address mapping table for quicker address mapping.

Examples of mapping methods used by the non-volatile semiconductor memory 1 based on mapping function of the FTL includes various methods for different units by which mapping is to be performed, e.g., a sector mapping algorithm, a page mapping algorithm, a block mapping algorithm, and a log block algorithm, which is a combination of the block mapping algorithm and the page mapping algorithm. The smaller the unit by which mapping is performed, the larger the size of the overall mapping table becomes. Also, the larger the unit by which mapping is performed, the smaller the size of the overall mapping table becomes. A size of a mapping table may be determined with the amount of RAM required by the mapping table. A mapping algorithm may be determined based on the capacity of a RAM included in the data storage device 10.

Since the page mapping algorithm permits a high degree of freedom for writing data to other sectors of a new block, the page mapping algorithm improves a random writing performance. The page mapping algorithm is managed as described below. If it is assumed that one non-volatile semiconductor memory 1 (e.g., a NAND flash memory) is a single block and data is sequentially written. Physical page addresses of 0 through 63 pages are stored in pages 0 through page 63 of a block 0, whereas physical page addresses of 64 through 127 pages are stored in pages 0 through page 63 of a block 1. Sequence numbers are sequentially written in the order of pages of a NAND flash memory, the pages to which data is written. Alternatively, the sequence numbers may be randomly written.

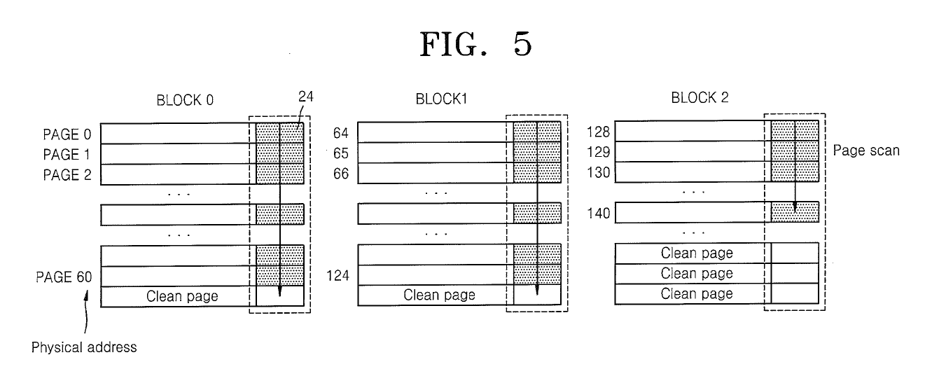

In the case where the data storage device 10 experiences sudden power failure or an error in a metatable, the FTL composes a page map table, which indicates correspondence between logical page addresses and physical page addresses, based on an internal status of the non-volatile semiconductor memory 1, that is, a NAND flash memory. In this case, as shown in FIG. 5, since it is necessary for the FTL to compose a page map table by reading all pages, massive volume of a reading operation is performed, and thus the processing speed of a system is deteriorated. To resolve such a problem, it is necessary to manage the non-volatile semiconductor memory 1 by employing a method of storing at least two forward links in a spare sector 24 of each page.

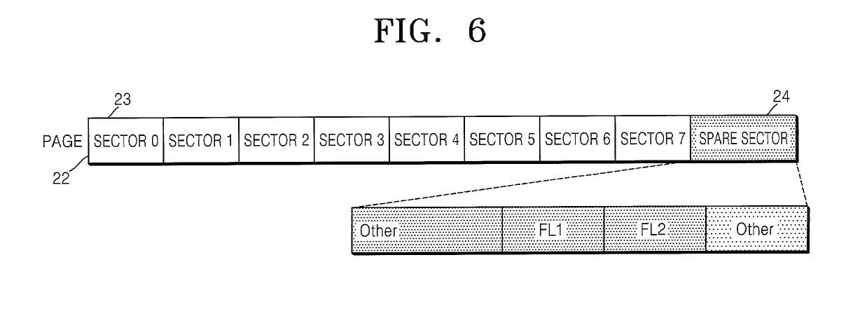

FIG. 6 is a diagram showing data stored in the spare sector 24 according to an embodiment of the inventive concept. Referring to FIG. 6, the spare sector 24 storing metadata stores miscellaneous data including at least two forward links FL1 and FL2, ECC parities, numbers of cycles of programming and erasing, etc. The forward links FL1 and FL2 are data indicating location of a next page in which data is stored. The at least two forward links FL1 and FL2 stored in the spare sector 24 are referred to as a forward link or a skip link. To store the at least two forward links FL1 and FL2, the non-volatile semiconductor memory 1 supports at least one number of times of programming (NOP).

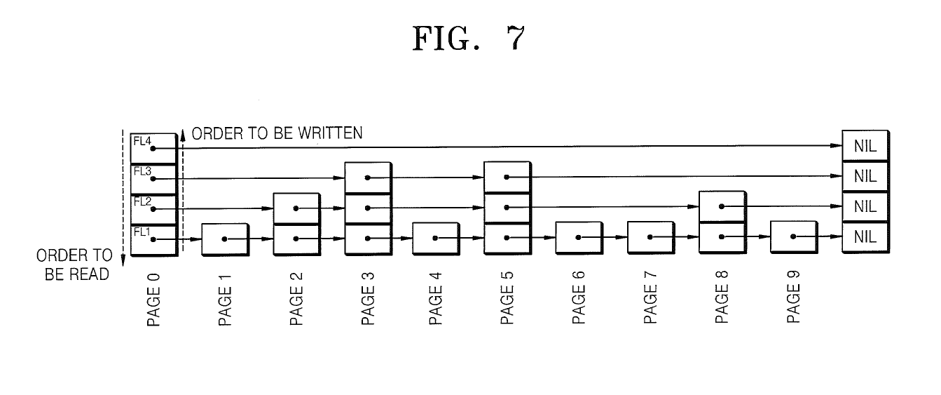

FIG. 7 is a diagram for describing a function of the forward links FL1 and FL2 of FIG. 6. FIG. 7 shows an example where four forward links, namely, first through fourth forward links FL1, FL2, FL3, and FL4 are stored in the spare sector 24. The first through fourth forward links FL1 through FL4 are stored in the page 0, the first forward link FL1 is stored in the page 1, and the first and second forward links FL1 and FL2 are stored in the page 2.

The first through fourth forward links FL1, FL2, FL3, and FL4 are written to the spare sector 24 on the page 0 in the order stated. In other words, the location of a page having next data is updated from the first forward link FL1 to the second forward link FL2, is updated from the second forward link FL2 to the third forward link FL3, and is updated from the third forward link FL3 to the fourth forward link FL4. Therefore, the fourth forward link FL4, which is written to the spare sector 24 at the end, informs the location of a page having next data.

The first through fourth forward links FL1, FL2, FL3, and FL4 written to the spare sector 24 are read on the page 0 in the order of the fourth forward link FL4, the third forward link FL3, the second forward link FL2, and the first forward link FL1. If “NIL” is read from one of the first through fourth forward links FL1, FL2, FL3, and FL4, it means that a particular forward link from which “NIL” is read does not have the location of a linked page and is an invalid forward link Therefore, a next forward link is read. Since “NIL” is read from the fourth forward link FL4 of the page 0, the third forward link FL3 is read. Since the third forward link FL3 of the page 0 has the address of the page 3, it is clear that next data is stored on the page 3. Therefore, the address of the page 2 written to the second forward link FL2 of the page 0 and the address of the page 1 written to the first forward link FL1 of the page 0 become invalid addresses.

The “NIL” indicating an invalid forward link may be randomly set by a user. For example, a user may write “FFFFh” to the first through fourth forward links FL1, FL2, FL3, and FL4 to indicate that a forward link is read “NIL.”

On the page 1, since the second, third, and fourth forward links FL2, FL3, and FL4 are read “NIL,” only the first forward link FL1 is valid. However, since it is indicated on page 0 that next data is stored on the page 3, the first forward link FL1 of the page 1 is not read. In the same regard, the second forward link FL2 and the first forward link FL1 of the page 2 are not read.

On the page 3, since the address of the page 5 is written to the third forward link FL3, it is clear that next data is stored on the page 5. On the page 5, since “NIL” is written to the third forward link FL3, the address of the page 8 written to the second forward link FL2 is read. On the page 8, since “NIL” is written to the second forward link FL2, the address of the page 9 written to the first forward link FL1 is read.

Accordingly, metadata is read from the FTL by using the first through fourth forward links FL1, FL2, FL3, and FL4 in the order of the page 0, the page 3, the page 5, the page 8, and the page 9. Therefore, the overhead of composing a mapping table by reading all pages may be reduced.

In FIG. 7, since the first through fourth forward links FL1, FL2, FL3, and FL4 are written to the spare sector 24 in the order stated, the fourth forward link FL4 is the most reliable forward link. Therefore, the FTL determines that the fourth forward link FL4, the uppermost forward link, is the most reliable forward link from among the read first through fourth forward links FL1, FL2, FL3, and FL4.

On the contrary, in the case where the first through fourth forward links FL1, FL2, FL3, and FL4 are written to the spare sector 24 in the order of the fourth forward link FL4, the third forward link FL3, the second forward link FL2, and the first forward link FL1, the first forward link FL1 is the most reliable forward link. In this case, the FTL determines that the first forward link FL1, the lowermost forward link, is the most reliable forward link.

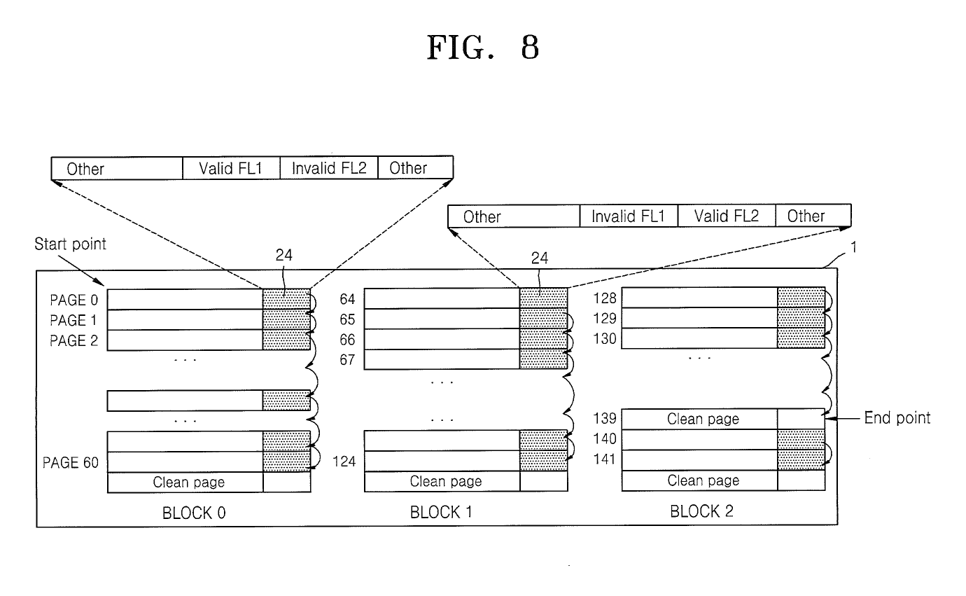

FIG. 8 is a diagram for describing a method of managing the non-volatile semiconductor memory 1 by using a plurality of forward links stored in the spare sector of FIG. 6. In FIG. 8, the first and second forward links FL1 and FL2 are distinguished as a valid forward link and an invalid forward link. A valid forward link is the most reliable forward link. In the block 0, the address of the page 1 is written to a valid forward link of the page 0. For convenience of explanation, it is assumed that the first forward link FL1 is a valid forward link and the second forward link FL2 is an invalid forward link. The address of the page 2 is written to the first forward link FL1 of the page 1, and the address of the page 3 is written to the first forward link FL1 of the page 2. It is clear that the addresses of pages storing next data are sequentially written in the block 0.

On the pages 65 and 66 of the block 1, the addresses of the pages storing next data are changed. The changed pages are the pages 140 and 141 of the block 2. The addresses of the pages 140 and 141 are successively stored on the page 139, which is the last page of the block 2 storing corresponding data. Therefore, on the page 64, the first forward link FL1 storing the address of the page 65 becomes an invalid forward link, and the address of the changed page 140 is written to the second forward link FL2. The second forward link FL2 of the page 64 becomes a valid link.

The address of the page 141 is written to the first forward link FL1 of the page 140, and the address of the page 67 is written to the first forward link FL1 of the page 141. The address of the page 68 is written to the first forward link FL1 of the page 67. The addresses of the pages storing next data are sequentially written to the first forward links FL1 of the corresponding pages from the page 67 of the block 1 to the page 138 of the block 2. Since “NIL” is written to the first forward link FL1 of the page 139 of the block 2, the page 139 becomes the last page storing data, that is, the ending point.

Accordingly, metadata is read from the FTL by using the forward links in the order of the page 0, the page 1, . . . , the page 60, the page 64, the page 140, the page 141, the page 67, the page 68, . . . , the page 124, the page 128, the page 129, . . . , and the page 139. Therefore, even if metadata to be updated after the page 139, which is the last page storing metadata, is stored on the pages 140 and 141 in the non-volatile semiconductor memory 1, the FTL may recover a mapping table without scanning and merging all pages.

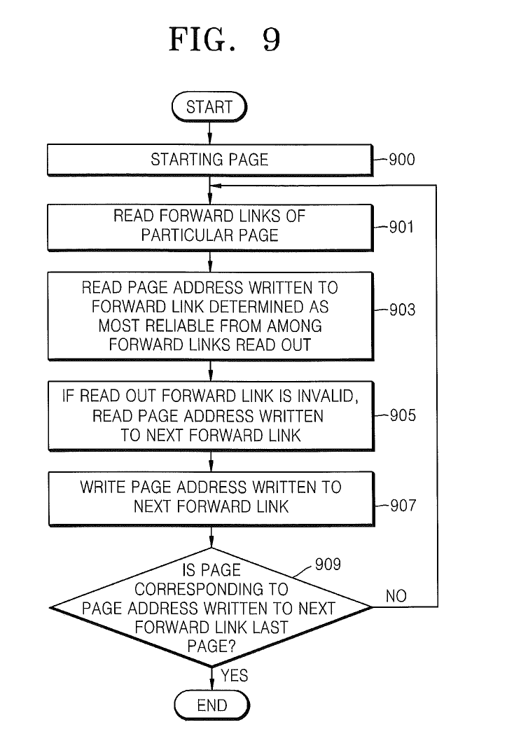

FIG. 9 is a flowchart of a method of composing a mapping table as described above with reference to FIG. 8. Referring to FIG. 9, the FTL reads first and second forward links FL1 and FL2 of corresponding pages from a starting page (operation 900) in which data of the non-volatile semiconductor memory 1 is stored (operation 901). The FTL determines the second forward link FL2, which is the uppermost forward link, as the most reliable forward link, for example. The address of a page written to the second forward link FL2, which is determined as the most reliable forward link, is read out (operation 903). If the address of the page written to the second forward link FL2 is “NIL,” the second forward link FL2 becomes an invalid forward link. In this case, the address of a page written to the first forward link FL1, which is the next forward link, is read out (operation 905). The address of the page written to the first forward link FL1 is written to the mapping table (operation 907). The operation of composing the mapping table as described above is repeatedly performed to the last page storing data (operation 909).

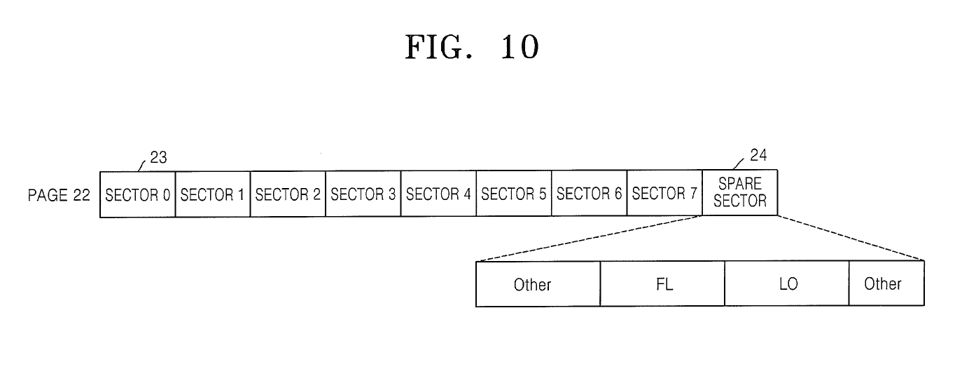

FIG. 10 is a diagram showing data stored in the spare sector 24 according to another embodiment of the inventive concept. Referring to FIG. 10, the spare sector 24 storing metadata stores miscellaneous data including a forward link FL, a link offset LO, ECC parities, numbers of cycles of programming and erasing, etc. The forward link FL is data indicating the address of a next page storing data. The link offset LO is data indicating the location of a page storing previous data when data is updated. The link offset LO indicates data of which page from among previously read pages is replaced by data stored at the corresponding page address.

Information stored in the link offset LO for indicating the location of data on a previous page may be embodied in various forms. The link offset LO may store the address of a page storing previous data. Alternatively, the link offset LO may store a value corresponding to a difference between the address of a page storing updated data and the address of a page storing previous data. Alternatively, the link offset LO may store a value corresponding to a difference between the address of a starting page and the address of a page storing previous data.

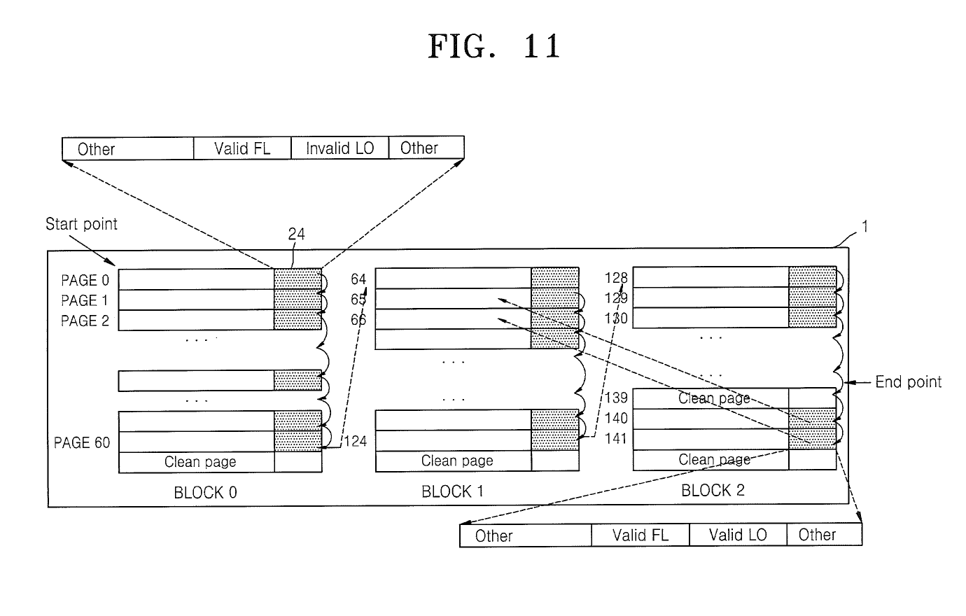

FIG. 11 is a diagram for describing a method of managing the non-volatile semiconductor memory 1 by using the forward link FL and the link offset LO stored in a spare sector 24 of FIG. 10. For convenience of explanation, in FIG. 11, like as the non-volatile semiconductor memory 1 of FIG. 8 described above, the addresses of the pages storing next data are changed on the pages 65 and 66 of the block 1.

In the block 0, the address of the page 1 is written to the forward link of the page 0, and an invalid value, e.g., “NIL,” is written to the link offset. The link offset of the page 0 becomes an invalid link offset. The address of the page 2 is written to the first forward link of the page 1, and the address of the page 3 is written to the first forward link of the page 2. The addresses of pages storing next data are sequentially written to the forward links FL of each page of the block 0. In pages from the page 1 through page 60, the link offsets of each of the pages are invalid link offsets.

The address of the page 65 is written to the forward link of the page 64 of the block 1, and the address of the page 66 is written to the forward link of the page 65. The addresses of pages storing next data are sequentially written to the forward links FL of each page of the block 1. In the block 1, the link offsets of each of the pages are invalid link offsets.

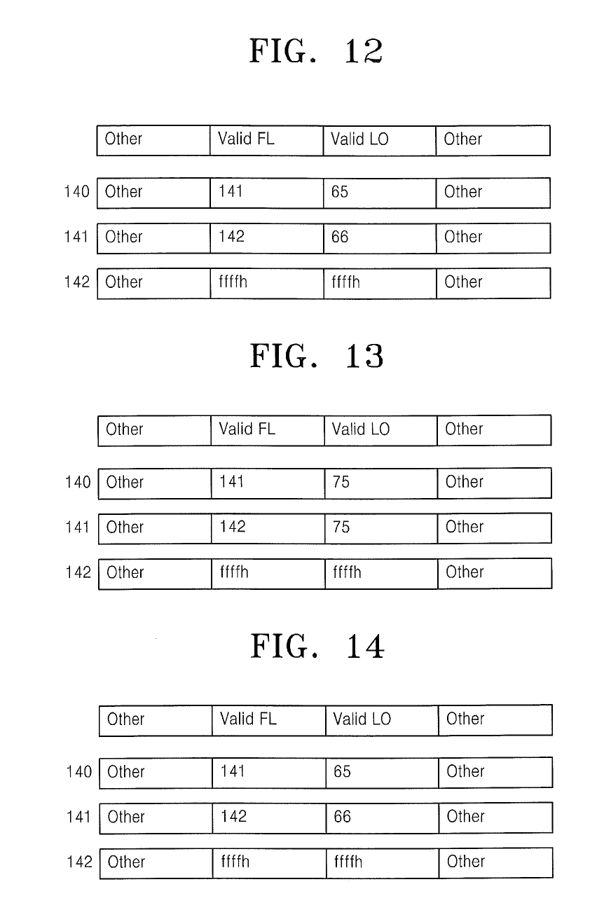

The addresses of pages storing next data are sequentially written to the forward links FL of pages of the block 2 from the page 128 through the page 138, wherein the link offsets of each of the pages are invalid link offsets. Since “NIL” is written to the forward link of the page 139, the page 139 becomes the last page storing data, that is, the ending point. The forward links FL and the link offsets LO are written on the pages 140 and 141 in the same method described with reference to FIGS. 12 through 14.

In FIG. 12, the address of a page storing previous data is written to the link offset. Referring to FIG. 12, the address of the page 141 is written to the forward link FL of the page 140, and the address of the page 65 storing previous data is written to the link offset of the page 141. Therefore, the page 140 corresponds to the updated address of the page 65. The address of the page 142 storing next data is written to the forward link FL of the page 141, and the address of the page 66 storing previous data is written to the link offset LO. Therefore, the page 141 corresponds to the updated address of the page 66. The link offsets of the pages 140 and 141 are valid link offsets. Since “NIL” is written to the forward link FL and the link offset LO of the page 142, the forward link FL, and the link offset LO of the page 142 are invalid.

In FIG. 13, a value corresponding to a difference between the address of a page storing updated data and the address of a page storing previous data is written to the link offset. Referring to FIG. 13, the address of the page 141 is written to the forward link FL of the page 140, and a value 75 is written to the link offset of the page 140. A value 65 obtained by subtracting 75, which is the value of the link offset, from 140, which is the page number, corresponds to the updated address of the page 65. The address of the page 142 storing next data is written to the forward link FL of the page 141, and a value 75 is written to the link offset LO. Therefore, the value 66 obtained by subtracting 75, which is the value of the link offset, from 141, which is the page number, corresponds to the updated address of the page 66. The link offsets of the pages 140 and 141 are valid.

In FIG. 14, a value corresponding to a difference between the address of a starting page and the address of a page storing previous data is written to the link offset. Referring to FIG. 14, the address of the page 141 is written to the forward link FL of the page 140, and a value 65 is written to the link offset of the page 140. As shown in FIG. 11, the address of the starting page is 0, and thus a value 65 corresponding to a difference between the address of the page 0, which is the starting page, and the address of the page 65 storing previous data is written to the link offset of the page 140. Therefore, the page 140 corresponds to the updated address of the page 65. The address of the page 142 is written to the forward link FL of the page 141, and a value 66 corresponding to a difference between the address of the page 0, which is the starting page, and the address of the page 66 storing previous data is written to the link offset of the page 141. Therefore, the page 141 corresponds to the updated address of the page 66.

If it is assumed that the address of the starting page written to the link offsets of FIG. 14 is 10, a value 55 corresponding to a difference between the address of the page 10, which is the starting page, and the address of the page 65 storing previous data is written to the link offset of the page 140, whereas a value 56 corresponding to a difference between the address of the page 10, which is the starting page, and the address of the page 66 storing previous data is written to the link offset of the page 141. Therefore, the page 140 corresponds to the updated address of the page 65, whereas the page 141 corresponds to the updated address of the page 66.

As described above with reference to FIGS. 12 through 14, by using a forward link, which indicates the location of a page storing next data, and a link offset, which indicates the location of a page storing previous data updated by data of a corresponding page, a mapping table may be accurately recovered.

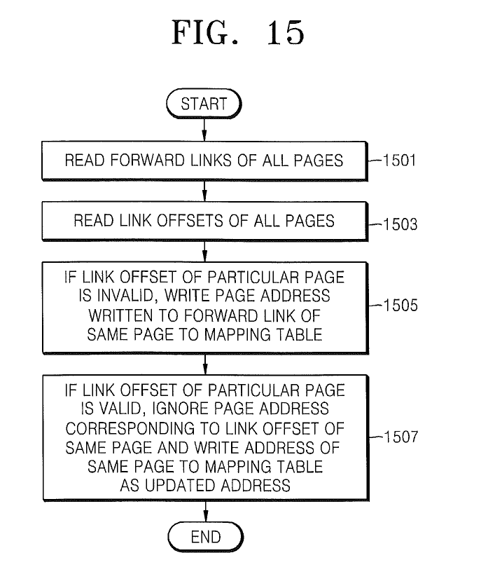

FIG. 15 is a flowchart of a method of composing a mapping table by using a forward link and a link offset stored in the spare sector of FIG. 10. Referring to FIG. 15, the FTL reads out forward links and link offsets of all pages of the non-volatile semiconductor memory 1 (operations 1501 and 1503). In the case where the link offset of a particular page is invalid, the FTL writes the page address written to the forward link of the particular page to the mapping table (operation 1505). In the case where the link offset of a particular page is valid, the FTL ignores a page address corresponding to the link offset of the particular page and writes the address of the particular page to the mapping table as an updated address (operation 1507).

While the inventive concept has been particularly shown and described with reference to exemplary embodiments thereof, it will be understood that various changes in form and details may be made therein without departing from the spirit and scope of the following claims.

1. A method of operating an integrated circuit device, comprising:
updating a mapping table with physical address information by reading forward link information from a plurality of spare sectors in a corresponding plurality of pages within a nonvolatile memory device and writing mapping table information derived from the forward link information into the mapping table.

2. The method of claim 1, wherein said updating comprises updating a mapping table within a volatile memory, in response to a resumption of power within the integrated circuit device.

3. The method of claim 2, wherein the mapping table within the volatile memory operates as a flash translation layer that supports conversion of logical addresses received by the integrated circuit device into physical addresses within the nonvolatile memory device.

4. The method of claim 1, wherein the mapping table within the volatile memory operates as a flash translation layer that supports conversion of logical addresses received by the integrated circuit device into physical addresses within the nonvolatile memory device.

5. The method of claim 1, wherein the plurality of spare sectors retain error checking and correction codes and metadata.

6. The method of claim 1, further comprising writing updated forward link information into the plurality of spare sectors in response to writing new data into the plurality of pages within a nonvolatile memory device.

7. The method of claim 1, wherein the forward link information includes forward link offset information.

8.-17. (canceled)

18. A method of data management in a data storage device comprising a non-volatile semiconductor memory that is divided into a plurality of blocks, wherein each of the plurality of blocks is divided into a plurality of pages, and each of the plurality of pages comprises a data sector and a memory sector; and a control device, which controls the data storage device, such that at least two forward links for indicating the locations of pages storing next data are stored in a spare sector of each of the pages of each of the blocks, the method comprising:
an operation of reading the at least two forward links;
an operation of reading a page address written to a forward link, which is determined as the most reliable forward link, among the at least two forward links; and
an operation of writing the page address written to the most reliable forward link to a mapping table.

19. The method of claim 18, wherein an uppermost forward link, which is farther away from the data sector, among the at least two forward links is determined as the most reliable forward link.

20. The method of claim 18, wherein a lowermost forward link, which is closer to the data sector, among the at least two forward links is determined as the most reliable forward link.

21. The method of claim 18, wherein, if a forward link determined as the most reliable forward link among the at least two forward links is an invalid forward link, a page address written to a next forward link is read out and the page address written to the next forward link is written to the mapping table.

22. The method of claim 18, wherein the invalid forward link is set by a user-defined number.

23. A method of data management in a data storage device comprising a non-volatile semiconductor memory that is divided into a plurality of blocks, wherein each of the plurality of blocks is divided into a plurality of pages, and each of the plurality of pages comprises a data sector and a memory sector; and a control device, which controls the data storage device, such that a forward link for indicating the locations of pages storing next data and a link offset for indicating the location of a page storing previous data updated by data of a corresponding page are stored in a spare sector of each of the pages of each of the blocks, the method comprising:
an operation of reading forward links of all of the plurality of pages;
an operation of reading link offsets of all of the plurality of pages;
an operation of writing a page address stored in the forward link of a particular page to a mapping table if the link offset of the particular page is invalid; and
an operation of ignoring a page address corresponding to the link offset of a particular page and writing the address of the particular page to the mapping table as an updated address if the link offset of the particular page is valid.

24. The method of claim 23, wherein the link offset stores the address of the page storing the previous data.

25. The method of claim 23, wherein the link offset stores a value corresponding to a difference between the address of a page storing updated data and the address of a page storing previous data.

26. The method of claim 23, wherein the link offset stores a value corresponding to a difference between the address of a starting page and the address of a page storing previous data.

27. The method of claim 23, wherein the link offset is set to an invalid link offset by a user-defined number.
